(19) United States
(12) Patent Application Publication
(10) Pub. No.: US 2022/0236996 A1
(43) Pub. Date: Jul. 28, 2022

(54) DUAL-SYSTEM DEVICE AND METHOD FOR DISPLAYING APPLICATION THEREOF, AND STORAGE MEDIUM

(71) Applicant: BOE Technology Group Co., Ltd., Beijing (CN)

(72) Inventor: Feng FENG, Beijing (CN)

(21) Appl. No.: 17/578,291

(22) Filed: Jan. 18, 2022

(30) Foreign Application Priority Data
Jan. 28, 2021 (CN) 202110119963.3

(51) Int. Cl. G06F 9/4401; G06F 13/38; G06F 11/14

(52) U.S. Cl. CPC G06F 9/441; G06F 2213/0042; G06F 11/1441; G06F 13/385

(57) ABSTRACT

A dual-system device and a method for displaying an application thereof, and a storage medium are provided. The dual-system device is configured with a first operating system and a second operating system, a first daemon is configured in the first operating system, and a second daemon is configured in the second operating system. The method includes: completing registration of a first application and generating a first registration list in the first daemon, the first application being an application in the first operating system; acquiring the first registration list of the first operating system from the first daemon by using the second daemon; and displaying the first application in the second operating system based on the first registration list.

### CROSS-REFERENCE TO RELATED APPLICATION

This application claims priority of Chinese Patent Application No. 202110119963.3, filed on Jan. 28, 2021 and entitled “DUAL-SYSTEM DEVICE AND METHOD FOR DISPLAYING APPLICATION THEREOF, AND STORAGE MEDIUM”, the disclosure of which is incorporated herein by reference in its entirety.

### TECHNICAL FIELD

The present disclosure relates to the field of computer technologies, and in particular to a dual-system device and a method for displaying an application thereof, and a storage medium.

### BACKGROUND

A dual-system device generally refers to an electronic device that is capable of running two operating systems. Due to the capability of running two operating systems, the dual-system device has advantages of both operating systems simultaneously.

### SUMMARY

The present disclosure provides a dual-system device and a method for displaying an application thereof, and a storage medium.

According to a first aspect of the present disclosure, a method for displaying an application of a dual-system device is provided. The dual-system device is configured with a first operating system and a second operating system, a first daemon is configured in the first operating system, and a second daemon is configured in the second operating system. The method includes: completing registration of a first application and generating a first registration list in the first daemon, the first application being an application in the first operating system; acquiring the first registration list of the first operating system from the first daemon by using the second daemon; and displaying the first application in the second operating system based on the first registration list.

According to a second aspect of the present disclosure, a dual-system device is provided. The dual-system device is configured with a first operating system and a second operating system, a first daemon is configured in the first operating system, and a second daemon is configured in the second operating system. The device includes: a first processing unit configured to: run the first operating system; and complete registration of a first application and generate a first registration list in the first daemon, the first application being an application in the first operating system; a second processing unit electrically coupled to the first processing unit and configured to: run a second operating system; and acquire the first registration list of the first operating system from the first daemon of the first processing unit by using the second daemon; and a display unit electrically coupled to the second processing unit, wherein the second processing unit is further configured to display the first application in the second operating system based on the first registration list through the display unit.

According to a third aspect of the present disclosure, a non-transitory computer-readable storage medium is provided. The non-transitory computer-readable storage medium stores computer instructions therein, and the computer instructions are loaded and executed by a computer to perform the method according to the first aspect of the present disclosure.

### BRIEF DESCRIPTION OF THE DRAWINGS

FIG. 1 is a structural schematic diagram illustrating a dual-system device according to an embodiment of the present disclosure;

FIG. 2 is a schematic diagram illustrating a system architecture according to an embodiment of the present disclosure;

FIG. 3 is a schematic diagram illustrating interaction between publish and subscribe modules according to an embodiment of the present disclosure;

FIG. 4 is a schematic diagram illustrating an interface according to an embodiment of the present disclosure; and

FIG. 5 is a flowchart illustrating a method according to an embodiment of the present disclosure.

### DETAILED DESCRIPTION

For clearer descriptions of the objectives, technical solutions, and advantages of the present disclosure, the present disclosure is described in detail hereinafter in combination with specific embodiments and with reference to the accompanying drawings.

It is to be noted that, unless otherwise defined, technical terms or scientific terms used in the present disclosure should have general meanings understood by those of ordinary skill in the art. The words “first”, “second” and similar terms used in the present disclosure do not indicate any order, quantity, or importance, and are merely intended to distinguish different components. The word such as“include” or “comprise” and similar terms are intended to indicate that an element or object appearing before the word covers elements or objects and their equivalents listed after the word While other elements or objects are not excluded. The word such as “connected” or “coupled” and similar terms are not limited to physical or mechanical connection, and may include direct or indirect electrical connection.

At present, interactive whiteboards and large-sized commercial display devices generally adopt a dual system, including, Android and Windows. A main control board of the device adopts an Android system, and is connected to a host computer running the Windows system through an onboard open pluggable specification (OPS) interface. Thus, users may not only use a large screen driven by the Android system with low power consumption, but also use the Windows system and applications thereof conveniently.

The OPS interface generally supports signals of a high-definition multimedia interface (HDMI) and a digital visual interface (DVI). For the Android system, the host computer running the Windows system actually is a signal. Therefore, during use, users may use Android applications in the Android system, or use applications in the Windows system by switching a signal source to a signal source of the Windows system. In this case, users need to manually switch the signal source, resulting in low use efficiency. Furthermore, as the two operating systems are of completely different styles, inconsistent operations and experiences may be caused to users.

In view of this, the present disclosure provides a dual-system device and a method for displaying an application thereof. Registration of a first application is completed and a first registration list is generated in a first daemon of a first operating system, and registration of a second application is completed and a second registration list is generated in a second daemon of a second operating system. Then, the first registration list is acquired from the first daemon by using the second daemon; and the first application of the first operating system and the second application of the second operating system are displayed in the second operating system in combination with the first registration list and the second registration list. Therefore, applications in two operating systems may be displayed on the same interface, so that a user may operate the applications in two operating systems on the same interface, thereby omitting the operation of switching the operating system of the user, improving the use efficiency, and maintaining the unified interface.

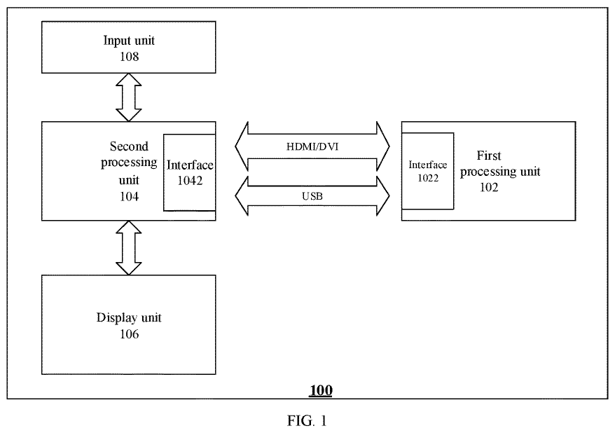

FIG. 1 is a structural schematic diagram illustrating a dual-system device 100 according to an embodiment of the present disclosure.

As shown in FIG. 1, the dual-system device 100 may include a first processing unit 102, a second processing unit 104, a display unit 106 and an input unit 108. In some embodiments, the first processing unit 102 may be a host computer running a first operating system (for example, a Windows system); the second processing unit 104 may be a main control board running a second operating system (for example, an Android system); the display unit 106 may be a liquid crystal display, an organic light-emitting diode display, a light-emitting diode display, or the like; and the input unit 108 may be an external input device, such as a mouse and a keyboard, or may also be a module integrated with the dual-system device, for example, a touch structure. The touch structure and the display unit 106 may be integrated into a touch screen. In some embodiments, the first processing unit 102 may include an interface 1022, the second processing unit 104 may include an interface 1042, and the interface 1022 and the interface 1042 may he electrically coupled with each other through a communication connection line, so that the first processing unit 102 and the second processing unit 104 may transmit control signals to each other. In some embodiments, each of the interface 1022 and the interface 1042 may be an OPS interface, which may be integrated with a DVI/HDMI interface and a universal serial bus (USB) interface therein, so that the first processing unit 102 and the second processing unit 104 may transmit video signals and audio signals to each other through the DVI/HDMI interface, and transmit control signals to each other through the USB interface. Certainly, the foregoing descriptions are only several implementations of connecting the interface 1022 and the interface 1042, and do not limit the present disclosure. The interface 1022 and the interface 1042 may also be connected in other fashions, such as in a wireless connection.

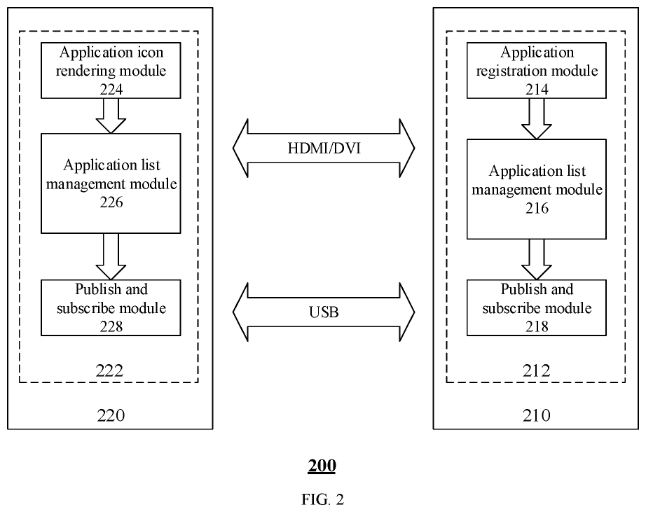

FIG. 2 is a schematic diagram illustrating a system architecture 200 according to an embodiment of the present disclosure.

As shown in FIG. 2, the first processing unit 102 may run a first operating system 210 (for example, a Window system), and start a first daemon 212 in the first operating system 210, and then complete registration of a first application and generate a first registration list in the first daemon 212. The first application is an application in the first operating system. For example, the first application is an application that runs in the first operating system.

The daemon is a special process that runs in the background, and is configured to perform specific system tasks. In the present disclosure, the daemon is mainly in charge of tasks such as registration of an application, generation and maintenance of a registration list, and interaction with other daemons.

In some embodiments, the first daemon 212 may further include an application registration module 214, an application list management module 216 and a publish and subscribe module 218. The application registration module 214 may be configured to register the first application of the first operating system 210 in an application management list of the first operating system 210. The application list management module 216 may be configured to accept the first application registered by the application registration module 214 and generate the first registration list, maintain and manage all applications installed in the first operating system 210, and update the first registration list. The publish and subscribe module 218 may be configured to acquire, by the second operating system 220, the first registration list and an update status of the first registration list.

As shown in FIG. 2, the second processing unit 104 may run a second operating system 220 (for example, an Android system), and start a second daemon 222 in the second operating system 220; acquire the first registration list of the first operating system 210 from the first daemon 212 of the first processing unit 102 by using the second daemon 222; and display the first application in the second operating system based on the first registration list through the display unit 106.

In an exemplary embodiment, the second processing unit 104 renders the first application of the first operating system 210 in the second operating system 220 based on the first registration list, so that the display unit 106 may display the rendered first application.

In some embodiments, the second daemon 222 may further include an application icon rendering module 224, an application list management module 226 and a publish and subscribe module 228. The application list management module 226 may be configured to manage a second application installed in the second operating system 220, and manage the first application installed in the first operating system 210 based on the first registration list. The publish and subscribe module 228 may be used by the second operating system 220 to subscribe the first registration list maintained in the application list management module 216 of the first operating system 210 and to acquire the update status of the first registration list (such as installation, uninstallation and upgrade of the first application), and may also report update information of the first application to the application list management module 226. The publish and subscribe module 228 may be further configured to acquire an icon of the first application of the first operating system 210 for the application icon rendering module 224 to complete rendering. The application icon rendering module 224 may be configured to render the first application based on the acquired icon of the first application, so that a rendering result may be displayed in the display unit 106.

In some embodiments, the second processing unit 104 may acquire the first registration list of the first operating system from the first daemon by using the second daemon based on a USB protocol.

Since a USB bus is integrated in the OPS interface, the first processing unit 102 and the second processing unit 104 may complete transmission of control signals based on the USB protocol. Thus, update information of status of some applications may be synchronized through the OPS interface by the publish and subscribe module. In some embodiments, the operation performed on applications of the first operating system by users in the second operating system may also be synchronized through the OPS interface based on the USB protocol.

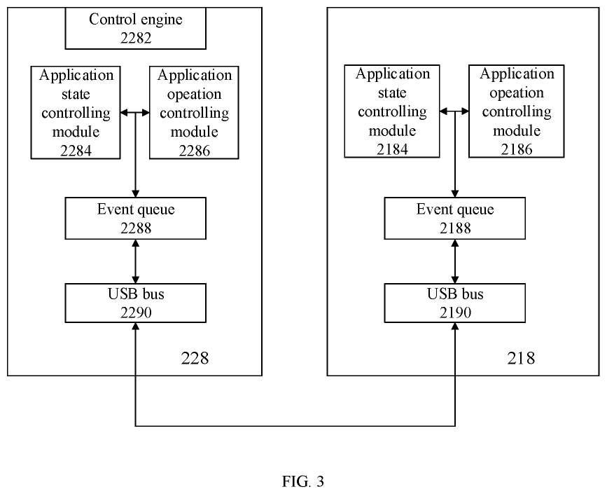

FIG. 3 is a schematic diagram illustrating interaction between a publish and subscribe module 218 and a publish and subscribe module 228 according to an embodiment of the present disclosure.

In some embodiments, as shown in FIG. 3, the publish and subscribe module 228 of the second daemon 222 may include a control engine 2282. The control engine 2282 is in charge of judging whether the application which is opened, closed or operated by the user is an application of the current operating system or is a cross-system application, and setting and judging a signal source label.

The publish and subscribe module 228 may further include an application state controlling module 2284 and an application operation controlling module 2286. The application state controlling module 2284 publishes and subscribes events including uninstallation, installation and update of an application, and the like, and the application operation controlling module 2286 is in charge of events including opening, closing and operation of an application, and the like. The control engine 2282 distributes different events to different modules. Similarly, the publish and subscribe module 218 may further include an application state controlling module 2184 and an application operation controlling module 2186 with functions similar to those of the application state controlling module 2284 and the application operation controlling module 2286 respectively.

Bottom layers of both the publish and subscribe module 218 of the first operating system and the publish and subscribe module 228 of the second operating system adopt the USB protocol, and the publish and subscribe module 218 and the publish and subscribe module 228 may simulate the USB protocol into event nodes at which event queue 2188 and event queue 2288 are provided, respectively. The event queue 2188 and event queue 2288 are in charge of receiving events transmitted via USB bus 2190 and USB bus 2290, respectively.

The display unit 106 is electrically coupled to the second processing unit 104. The display unit 106 may display the rendered first application and the second application in the second operating system 220. The second application is an application in the second operating system 220. For example, the second application is an application running in the second operating system 220.

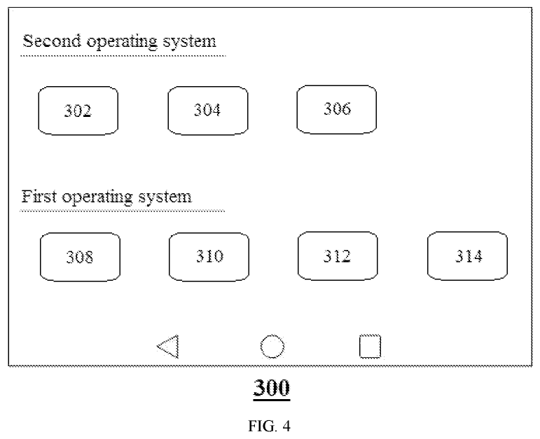

FIG. 4 is a schematic diagram illustrating an interface 300 according to an embodiment of the present disclosure. As shown in FIG. 4, applications in two operating systems are displayed on the interface 300. Second applications 302, 304 and 306 in the second operating system are displayed in the upper half part of the interface 300, and first applications 308, 310, 312 and 314 in the first operating system are displayed in the lower half part of the interface 300.

By displaying the applications in two operating systems on the same interface 300, users may conveniently select applications in different operating systems, without switching between two operating systems.

It is to be noted that FIG. 4 is only a schematic diagram illustrating the interface displayed by the display unit 106. It may be understood that the layout of the interface 300 may be flexibly adjusted according to requirements. For example, system labels “first operating system” and “second operating system” may be removed, or the first application and the second application may be mixed together, so that users may feel like running one operating system without perception of cross-system operation.

It may be known from the above embodiments that the dual-system device according to the present disclosure completes the registration of the first application and generates the first registration list in the first daemon of the first operating system, and completes the registration of the second application and generates the second registration list in the second daemon of the second operating system, and then acquires the first registration list from the first daemon by using the second daemon, thereby displaying the first application of the first operating system and the second application of the second operating system in the second operating system in combination with the first registration list and the second registration list. Therefore, applications in two operating systems may be displayed on the same interface, which omits the operation of switching between operating systems by users and maintaining the unified interface. The dual-system device according to the present disclosure can maximize the capability of the main control board of the device, and synchronize application states and control messages via the USB bus integrated in the OPS interface, which is high-efficient and lowers the complexity of program design. Thus, the dual-system devices have a broad application prospect on interactive whiteboards and large-sized commercial display devices.

In some embodiments, the input unit 108 is electrically coupled to the second processing unit 104, and may receive an application run instruction in the second operating system.

In response to the application corresponding to the application run instruction being the second application, the second processing unit 104 may directly run the second application; or in response to the application corresponding to the application run instruction being the first application, the second processing unit 104 needs to switch to the first operating system and send control information corresponding to the application run instruction to the first daemon 212 of the first processing unit 102 by using the second daemon 222. In some embodiments, the control information may be sent through the OPS interface based on the USB protocol.

In some embodiments, in response to the application corresponding to the application run instruction being the second application, the second processing unit 104 may also run the second application based on the application run instruction; and the first processing unit 102 may run the first application based on the control information corresponding to the application run instruction.

In some embodiments, after receiving the application run instruction, the second processing unit 104 may also modify a signal source label in the second operating system 220 to a first operating system label (for example, “MasterSys=Windows”); and then, switch to a signal source corresponding to the first operating system. After the signal source label is modified, the input unit 108, upon receiving a new instruction, may determine that the new instruction is sent for the first operating system by determining that the signal source label is the first operating system label, so as to send relevant control information of the new instruction to the first operating system for processing. Here, MasterSys represents the signal source label, and Windows represents the first operating system label.

Optionally, after the signal source label is modified, the second processing unit 104 may also synchronize the signal source label to, for example, the first processing unit 102 or other devices or units.

In some embodiments, the input unit 108 may receive an application close instruction of the first application in the second operating system.

The second processing unit 104 may, in response to the signal source label being the first operating system label, send control information corresponding to the application close instruction to the first daemon of the first processing unit by using the second daemon. In some embodiments, the control information may be sent through the OPS interface based on the USB protocol.

The first processing unit 102 may close the first application based on the control information corresponding to the application close instruction.

In some embodiments, the second processing unit 104 may switch to the second operating system and reset the signal source label to a second operating system label (for example, “MasterSys=Android”), and may also switch to a signal source corresponding to the second operating system. Here, Android represents the second operating system label.

In some embodiments, the action of switching to the second operating system performed by the second processing unit 104 may be triggered based on a system switching instruction. For example, a system switching button is displayed on an interface of the display unit 106, and the system switching instruction may be sent by clicking the system switching button. In some embodiments, when it is detected that the first applications in the first operating system 210 are all closed or no first application is running in the first operating system, it is considered that the user does not need to use the first operating system at present, and the action of switching the system is triggered to switch to the second operating system actively.

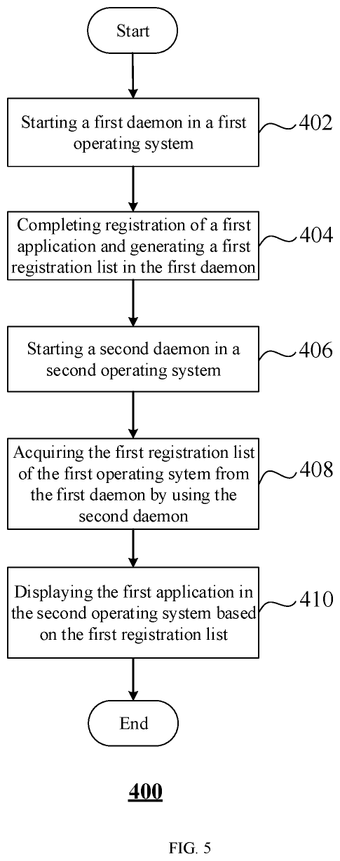

FIG. 5 is a flowchart illustrating a method 400 according to an embodiment of the present disclosure.

As shown in FIG. 5, the method 400 for displaying applications of a dual-system device may include the following steps.

In step 402, a first daemon is started in a first operating system.

In step 404, registration of a first application is completed and a first registration list is generated in the first daemon. The first application is an application in the first operating system.

In step 406, a second daemon is started in a second operating system.

Steps 402 and 406 are optional steps.

In step 408, the first registration list of the first operating system is acquired from the first daemon by using the second daemon.

In step 410, the first application is displayed in the second operating system based on the first registration list.

In some embodiments, the method 400 further includes: displaying a second application in the second operating system. The second application is an application in the second operating system.

In some embodiments, the method 400 further includes: receiving an application run instruction in the second operating system; in response to the application corresponding to the application run instruction being the first application, switching to the first operating system, and sending control information corresponding to the application run instruction to the first daemon by using the second daemon, so that the first operating system runs the first application based on the application run instruction; or in response to the application corresponding to the application run instruction being the second application, running the second application based on the application run instruction.

In some embodiments, switching to the first operating system includes: modifying a signal source label in the second operating system to a first operating system label; and switching to a signal source corresponding to the first operating system.

In some embodiments, the method 400 further includes: receiving an application close instruction of the first application in the second operating system; and in response to the signal source label being the first operating system label, sending control information of the application close instruction to the first daemon by using the second daemon, so that the first operating system closes the first application based on the control information of the application close instruction.

In some embodiments, the method 400 further includes: switching to the second operating system, and resetting the signal source label to a second operating system label.

In some embodiments, acquiring the first registration list of the first operating system from the first daemon by using the second daemon includes: acquiring the first registration list of the first operating system from the first daemon by using the second daemon based on a USB protocol.

The method of the above embodiment is used to implement the corresponding device in the foregoing embodiments, and has beneficial effects of the corresponding device embodiments. The beneficial effects are not repeated herein. It may be understood that the method may be performed by any apparatus, device, platform or device cluster with computing and processing capability.

It is to be noted that the method of the present disclosure may be performed by a single device, such as a computer or server. The method of the present disclosure may also be applied to a distributed scenario and completed by a plurality of devices through mutual operation. In this distributed scenario, one of the plurality of devices may perform only one or more steps in the method of the present disclosure, or the plurality of devices may interact with each other to complete the steps in the method.

It is to be noted that although the specific embodiments of the present disclosure are described above, other embodiments not described herein still fall within the scope of the appended claims. In some cases, desired results may still be achieved by performing actions or steps described in the claims in an order different from that in the embodiments. In addition, the desired results may be achieved without necessarily performing the process depicted in the accompanying drawings in a specific order or successive order shown herein. In some embodiments, multitasking and parallel processing is or may be advantageous.

The computer-readable storage medium in the embodiments includes permanent and non-permanent, mobile and non-mobile media that may store information by any method or technology. The information may be computer-readable instructions, data structures, program modules or other data. Examples of the computer storage medium include, but are not limited to, a phase change random access memory (PRAM), a static random access memory (SRAM), a dynamic random access memory (DRAM), and other types of random access memories (RAM), a read-only memory (ROM), an electrically-erasable programmable read-only memory (EEPROM), a flash memory or other memory technologies, a compact disk read-only memory (CD-ROM), a digital versatile disk (DVD) or other optical storages, magnetic cassettes, magnetic tapes, magnetic disk storages or other magnetic storage devices, or any other non-transmission media that may be configured to store information for access by a computing device.

Those of ordinary skill in the art should understand that the discussion of any of the above embodiments is only exemplary, and is not intended to imply that the scope of the present disclosure (including the claims) is limited to these embodiments. Based on the concept of the present disclosure, the above embodiments or technical features in different embodiments may also be combined, the steps may be performed in any order, and there may be many other changes in different aspects of the present disclosure as described above, which are not provided in details for clarity.

In addition, to simplify descriptions and discussion and make the present disclosure easy to understand, well-known connection between the power/ground and integrated circuit (IC) chips and other components may be shown or may be not shown in the accompanying drawings. In addition, the devices may be shown in the form of a block diagram, to make the present disclosure easy to understand and in consideration of the fact that the details about implementations of these block diagram devices are highly dependent on the platform on which the present disclosure is to be implemented (that is, these details should be completely within the understanding of those skilled in the art). In the case that the specific details (e.g., circuits) are set forth to describe the embodiments of the present disclosure, it is apparent to those skilled in the art that the present disclosure may be implemented without these specific details or in the case that these specific details are changed. Therefore, these descriptions should be considered as illustrative rather than restrictive of the present disclosure.

Although the present disclosure is described in combination with the specific embodiments, various substitutions, modifications and variations of these embodiments are apparent to those of ordinary skill in the art based on the foregoing descriptions. For example, other memory architectures may be used in the discussed embodiments.

The present disclosure is intended to include all of substitutions, modifications and variations falling within the broad scope of the appended claims. Therefore, any omissions, modifications, equivalent substitutions, improvements, and the like made within the spirit and principles of the present disclosure should be included in the scope of protection of the present disclosure.

What is claimed is:

1. A method for displaying an application of a dual-system device, wherein the dual-system device is configured with a first operating system and a second operating system, a first daemon being configured in the first operating system, and a second daemon being configured in the second operating system, the method comprising:
completing registration of a first application and generating a first registration list in the first daemon, the first application being an application in the first operating system;
acquiring the first registration list of the first operating system from the first daemon by using the second daemon; and
displaying the first application in the second operating system based on the first registration list.

2. The method according to claim 1, further comprising:
displaying a second application in the second operating system, the second application being an application in the second operating system.

3. The method according to claim 2, further comprising:
receiving an application run instruction in the second operating system; and
in response to an application corresponding to the application run instruction being the first application, switching to the first operating system and sending control information corresponding to the application run instruction to the first daemon by using the second daemon, so that the first operating system runs the first application based on the control information corresponding to the application run instruction; or
in response to the application corresponding to the application run instruction being the second application, running the second application based on the application run instruction.

4. The method according to claim 3, wherein switching to the first operating system comprises:
modifying a signal source label in the second operating system to a first operating system label; and
switching to a signal source corresponding to the first operating system.

5. The method according to claim 4, further comprising:
receiving an application close instruction of the first application in the second operating system; and
in response to the signal source label being the first operating system label, sending control information corresponding to the application close instruction to the first daemon by using the second daemon, so that the first operating system closes the first application based on the control information corresponding to the application close instruction.

6. The method according to claim 5, further comprising:
switching to the second operating system, and resetting the signal source label to a second operating system label.

7. The method according to claim 1, wherein acquiring the first registration list of the first operating system from the first daemon by using the second daemon comprises:
acquiring the first registration list of the first operating system from the first daemon by using the second daemon based on a universal serial bus (USB) protocol.

8. A dual-system device, wherein the dual-system device is configured with a first operating system and a second operating system, a first daemon being configured in the first operating system, and a second daemon being configured in the second operating system, the dual-system device comprising:
a first processing unit, configured to:
run the first operating system; and
complete registration of a first application and generate a first registration list in the first daemon, the first application being an application in the first operating system;
a second processing unit, electrically coupled to the first processing unit and configured to:
run the second operating system; and
acquire the first registration list of the first operating system from the first daemon of the first processing unit by using the second daemon; and
a display unit, electrically coupled to the second processing unit, wherein the second processing unit is further configured to:
display the first application in the second operating system based on the first registration list through the display unit.

9. The device according to claim 8, wherein the second processing unit is further configured to:
display a second application in the second operating system through the display unit, wherein the second application is an application in the second operating system.

10. The device according to claim 9, further comprising:
an input unit, electrically coupled to the second processing unit and configured: to receive an application run instruction in the second operating system;
wherein the second processing unit is further configured to:
in response to an application corresponding to the application run instruction being the first application, switch to the first operating system, and send control information corresponding to the application run instruction to the first daemon of the first processing unit by using the second daemon; or
in response to the application corresponding to the application run instruction being the second application, run the second application based on the application run instruction;
wherein the first processing unit is further configured to:
run the first application based on the control information corresponding to the application run instruction.

11. The device according to claim 10, wherein the second processing unit is further configured to:
modify a signal source label in the second operating system to a first operating system label; and
switch to a signal source corresponding to the first operating system.

12. The device according to claim 11, wherein
the input unit is further configured to receive an application close instruction of the first application in the second operating system;
the second processing unit is further configured to, in response to the signal source label being the first operating system label, send control information corresponding to the application close instruction to the first daemon of the first processing unit by using the second daemon; and
the first processing unit is further configured to close the first application based on the control information corresponding to the application close instruction.

13. The device according to claim 12, wherein the second processing unit is further configured to:
switch to the second operating system, and reset the signal source label to a second operating system label.

14. The device according to claim 8, wherein the second processing unit is further configured to:
acquire the first registration list of the first operating system from the first daemon by using the second daemon based on a universal serial bus (USB) protocol.

15. A non-transitory computer-readable storage medium storing computer instructions therein, wherein the computer instructions are loaded and executed by a computer to perform a method for displaying an application of a dual-system device, and the dual-system device is configured with a first operating system and a second operating system, a first daemon being configured in the first operating system, and a second daemon being configured in the second operating system, the method comprising:
completing registration of a first application and generating a first registration list in the first daemon, the first application being an application in the first operating system;
acquiring the first registration list of the first operating system from the first daemon by using the second daemon; and
displaying the first application in the second operating system based on the first registration list.

16. The non-transitory computer-readable storage medium according to claim 15, wherein the method further comprises:
displaying a second application in the second operating system, the second application being an application in the second operating system.

17. The non-transitory computer-readable storage medium according to claim 16, wherein the method further comprises:
receiving an application run instruction in the second operating system; and
in response to an application corresponding to the application run instruction being the first application, switching to the first operating system and sending control information corresponding to the application run instruction to the first daemon by using the second daemon, so that the first operating system runs the first application based on the control information corresponding to the application run instruction; or
in response to the application corresponding to the application run instruction being the second application, running the second application based on the application run instruction.

18. The non-transitory computer-readable storage medium according to claim 17, wherein switching to the first operating system comprises:
modifying a signal source label in the second operating system to a first operating system label; and
switching to a signal source corresponding to the first operating system.

19. The non-transitory computer-readable storage medium according to claim 18, wherein the method further comprises:
receiving an application close instruction of the first application in the second operating system; and
in response to the signal source label being the first operating system label, sending control information corresponding to the application close instruction to the first daemon by using the second daemon, so that the first operating system closes the first application based on the control information corresponding to the application close instruction.

20. The non-transitory computer-readable storage medium according to claim 19, wherein the method further comprises:
switching to the second operating system, and resetting the signal source label to a second operating system label.
